(19) United States
(12) Patent Application Publication
(10) Pub. No.: US 2013/0297725 A1
(43) Pub. Date: Nov. 7, 2013

(54) Control of Transmission to a Target Device with a Cloud-Based Architecture

(71) Applicant: ELWHA LLC, Bellevue, WA (US)

(72) Inventors: Robert W. Lord, Seattle, WA (US); Richard T. Lord, Tacoma, WA (US); Craig J. Mundie, Seattle, WA (US); Clarence T. Tegreene, Mercer Island, WA (US)

(73) Assignee: Elwha LLC, Bellevue, WA (US)

(21) Appl. No.: 13/729,802

(22) Filed: Dec. 28, 2012

Related U.S. Application Data
(63) Continuation-in-part of application No. 13/462,283, filed on May 2, 2012, now abandoned.
Application No. 13/462,283 is a continuation-in-part of application No. 13/678,010, filed on Nov. 15, 2012.
Application No. 13/678,010 is a continuation-in-part of application No. 13/678,082, filed on Nov. 15, 2012.
Application No. 13/678,082 is a continuation-in-part of application No. 13/707,261, filed on Dec. 6, 2012.

(51) Int. Cl. H04L 29/08

(52) U.S. Cl. CPC H04L 67/02
USPC 709/217

(57) ABSTRACT

Systems, methods, computer-readable storage mediums including computer-readable instructions and/or circuitry for control of transmission to a target device with a cloud-based architecture may implement operations including, but not limited to: computing, at least in part via a cloud architecture, a prospective transmission practicability index based at least in part on localized context information associated with a target device; comparing, at least in part via a cloud architecture, the prospective transmission practicability index against a threshold transmission practicability index associated with the target device; and transmitting, at least in part via a cloud-based architecture, at least one notification associated with the comparison to at least one transmission generating computing device.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority application(s)). In addition, the present application is related to the “Related applications,” if any, listed below.

### PRIORITY APPLICATIONS

For purposes of the USPTO extra-statutory requirements, the present application constitutes a continuation-in-part of the U.S. patent application Ser. No. 13/462,283, entitled Control of Transmission to a Target Device with a Cloud-Based Architecture, naming Robert W. Lord, Richard T. Lord, Craig J. Mundie, and Clarence T. Tegreene as inventors, filed May 2, 2012, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/678,010, entitled Control of Transmission to a Target Device with a Cloud-Based Architecture, naming Robert W. Lord, Richard T. Lord, Craig J. Mundie, and Clarence T. Tegreene as inventors, filed Nov. 15, 2012, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/678,082, entitled Control of Transmission to a Target Device with a Cloud-Based Architecture, naming Robert W. Lord, Richard T. Lord, Craig J. Mundie, and Clarence T. Tegreene as inventors, filed Nov. 15, 2012, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/707,261, entitled Control of Transmission to a Target Device with a Cloud-Based Architecture, naming Robert W. Lord, Richard T. Lord, Craig J. Mundie, and Clarence T. Tegreene as inventors, filed Dec. 6, 2012, which is currently co-pending or is an application of which a currently co-pending application is entitled to the benefit of the filing date.

### RELATED APPLICATIONS

None.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority applications section of the ADS and to each application that appears in the Priority applications section of this application.

All subject matter of the Priority applications and the Related applications and of any and all parent, grandparent, great-grandparent, etc. applications of the Priority applications and the Related applications, including any priority claims, is incorporated herein by reference to the extent such subject matter is not inconsistent herewith.

### SUMMARY

Systems, methods, computer-readable storage mediums including computer-readable instructions and/or circuitry for control of transmission to a target device with a cloud-based architecture may implement operations including, but not limited to: computing, at least in part via a cloud architecture, a prospective transmission practicability index based at least in part on localized context information associated with a target device; comparing, at least in part via a cloud architecture, the prospective transmission practicability index against a threshold transmission practicability index associated with the target device; and transmitting, at least in part via a cloud-based architecture, at least one notification associated with the comparison to at least one transmission generating computing device.

The foregoing summary is illustrative only and is not intended to be in any way limiting. In addition to the illustrative aspects, embodiments, and features described above, further aspects, embodiments, and features will become apparent by reference

### BRIEF DESCRIPTION OF THE FIGURES

FIG. 1 shows a high-level block diagram of an operational environment.

FIG. 2 shows a high-level block diagram of an operational environment.

FIG. 3 shows operations for control of transmission to a target device with a cloud-based architecture.

FIG. 4 shows operations for control of transmission to a target device with a cloud-based architecture.

FIG. 5 shows operations for control of transmission to a target device with a cloud-based architecture.

FIG. 6 shows operations for control of transmission to a target device with a cloud-based architecture.

FIG. 7 shows operations for control of transmission to a target device with a cloud-based architecture.

FIG. 8 shows operations for control of transmission to a target device with a cloud-based architecture.

FIG. 9 shows operations for control of transmission to a target device with a cloud-based architecture.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

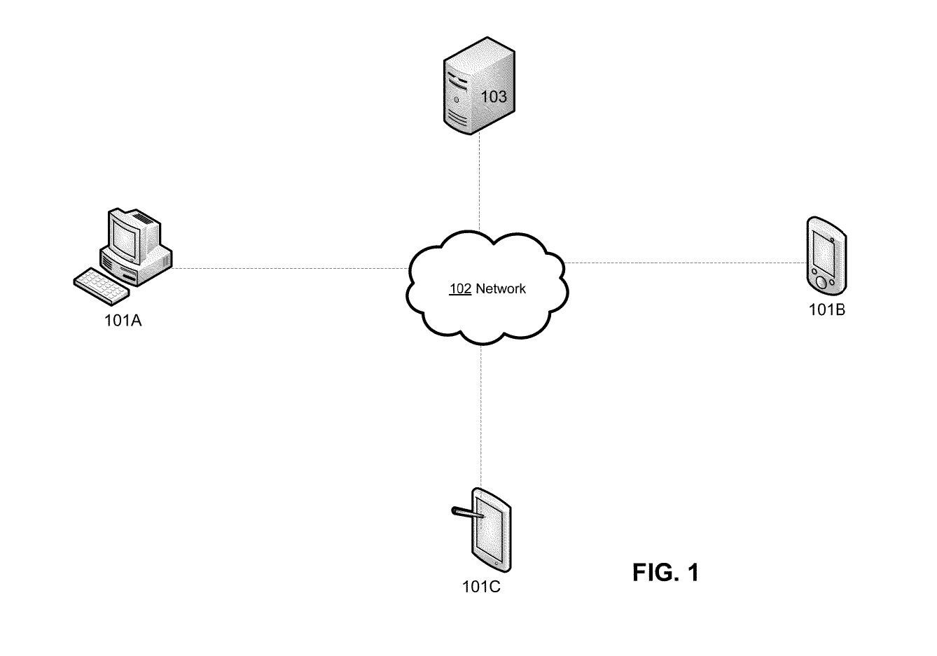

FIG. 1 is a block diagram of a cloud-based computing system 100 employing a cloud-based architecture. The cloud-based computing system 100 may include a variety of computing devices 101 connected via a network 102. The network 102 may be the Internet, a Local Area Network (LAN), a wireless network (such as a wireless LAN or WLAN), or other network, or a combination of networks. The cloud-based computing system 100 may further include a cloud-based server 103, operably coupled to the computing devices 101 via the network 102.

The computing devices 101 may each be any type of computer or computing device, such as a desktop computer, laptop computer, netbook, tablet computer, mobile computing device (such as a cell phone, smartphone, personal digital assistant or other mobile or handheld or wireless computing device), or any other computer/computing device. The computing devices 101 may include one or more of a user input/output devices such as a display, keyboard, and a pointing device (such as a track ball, mouse, touch pad, touch screen or other pointing device).

The computing devices 101 may include memory to store data and software/computer instructions, a processor for executing software/computer instructions and providing overall control to the computer. The computing devices 101 may each include an operating system (OS) stored in memory and executed at startup, for example.

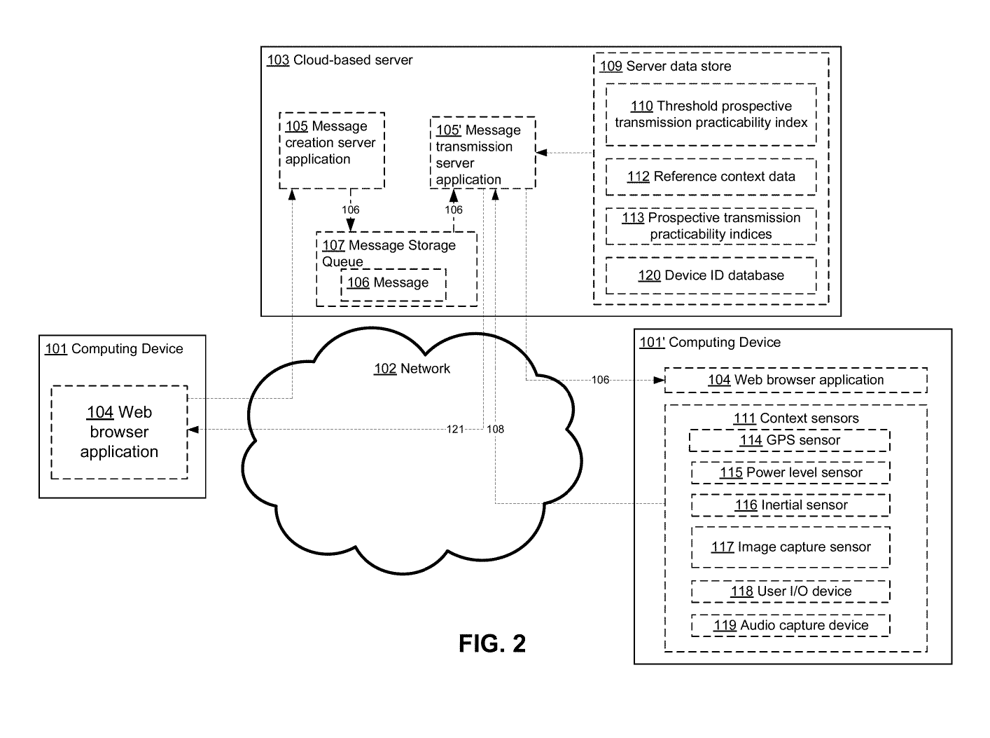

Referring to FIG. 2, the computing devices 101 may execute or run a web browser application 104 configured to access data maintained on one or more other computing devices 101 and/or the cloud-based server 103 via the network 102.

The cloud-based server 103 (which may include a processor and memory) may run one or more applications, such as server application 105 to provide a cloud-based service (or a cloud-based computing service) where cloud-based server 103 (and/or other servers associated with the cloud-based service) may provide resources, such as software, data, media (e.g., video, audio files) and other information, and management of such resources, to computing devices 101 via the network 102.

According to an example embodiment, computing resources such as application programs and file storage may be remotely provided by the cloud-based service (e.g., by cloud-based server 103) to a computing device 101 over the network 102 through the web browser application 104 running on the computing device 101. For example, a client computing device 101 may include the web browser application 104 running applications (e.g., Java applets or other applications), which may include application programming interfaces (“API's”) to more sophisticated applications (such as server application 105) running on remote servers that provide the cloud-based service (cloud-based server 103), as an example embodiment.

In an example embodiment, through the web browser application 104, a user can use a computing device 101 to log on to cloud-based services (e.g., by the web browser application 104 communicating with cloud-based server 103 of the cloud-based computing system 100) to access a server application 105. After logging-on to the server application 105, the user may create, edit, save and delete files on cloud-based server 103, and may establish (set up) or change/edit various options, such as user preferences and/or system settings, and/or may receive or download software (e.g., operating system or other software) or software updates, various data files or media files, user preferences and/or system settings, and other information previously stored on the cloud-based server 103, via the server application 105 running on the cloud-based server 103.

In an example embodiment, as shown in FIG. 2, a user of a first computing device 101 may compose a message 106 (e.g. an e-mail message, text message, instant message, or any other data transmission) for transmission to a target computing device 101 (e.g. target computing device 101′) via the cloud-based computing system 100. The first computing device 101 may access a message creation server application 105 running on cloud-based server 103 to compose the message 106 and the message 106 may be stored to a message storage queue 107 maintained in memory by the cloud-based server 103. The cloud-based server 103 may, in turn, employ a message transmission server application 105′ to transmit one or more messages 106 stored in the message storage queue 107 to the target computing device 101′. It will be noted that the determination of when to transmit messages 106 stored in the message storage queue 107 to the target computing device 101′ may carried out solely by the cloud-based server 103 architecture and not at the direction of either the transmitting computing device 101 or the target computing device 101′. Rather, the cloud-based server 103 may direct the transmission of messages 106 to the target computing device 101′ according to one or more cloud-based server defined parameters.

In an exemplary embodiment, the cloud-based server defined parameter may be associated with local environments and/or network connectivity parameters based on local context data 108 (e.g. location data, connection data, environmental data) associated with a given target computing device 101′. For example, the message transmission server application 105′ may be configured to authorize the transmission of messages 106 to the target computing device 101′ only when context data 108 (e.g. a network address, a geographical identifier, a power indicator, a bandwidth indicator, an inertial signal, an imaging signal, or a user input/output indicator, a communications signal strength, a connection type, etc.) associated with the target computing device 101′) indicates that there is a likelihood that a message 106 transmitted to the target computing device 101′ will be successful or occur in accordance with certain parameters (e.g. occur at a given speed, occur only when a device is in a specific location, occur only when the target computing device 101′ is capable of receiving a message 106, etc.). Specifically, the message transmission server application 105′ may be configured to authorize the transmission of messages 106 to the target computing device 101′ only when a prospective transmission practicability index computed from context data 108 associated with the target computing device 101′ complies with one or more threshold metrics maintained by a server data store 109 as a threshold prospective transmission practicability index 110 indicative of context data 108 having characteristics reflecting a likelihood of success in transmitting a message 106 to the target computing device 101′.

Specifically, the cloud-based server 103 may obtain/receive device identification data associated with the target computing device 101′ (e.g. a serial number, a model number, a network address) as well as context data 108 associated with the target computing device 101′. The message transmission server application 105′ may compare a transmission practicability index computed from the context data 108 associated with the target computing device 101′ to the threshold prospective transmission practicability index 110. If the transmission practicability index computed from the context data 108 associated with the target computing device 101′ complies with the threshold prospective transmission practicability index 110, the message transmission server application 105′ may authorize the transmission of a message 106 to the target computing device 101′. Otherwise, the message 106 may be retained in the message storage queue 107 until the transmission practicability index computed from the context data 108 associated with the target computing device 101′ complies with the threshold prospective transmission practicability index 110, if ever. The initiation of such transmissions by the message transmission server application 105′ may be wholly independent of any action by the computing device 101 or the target computing device 101′.

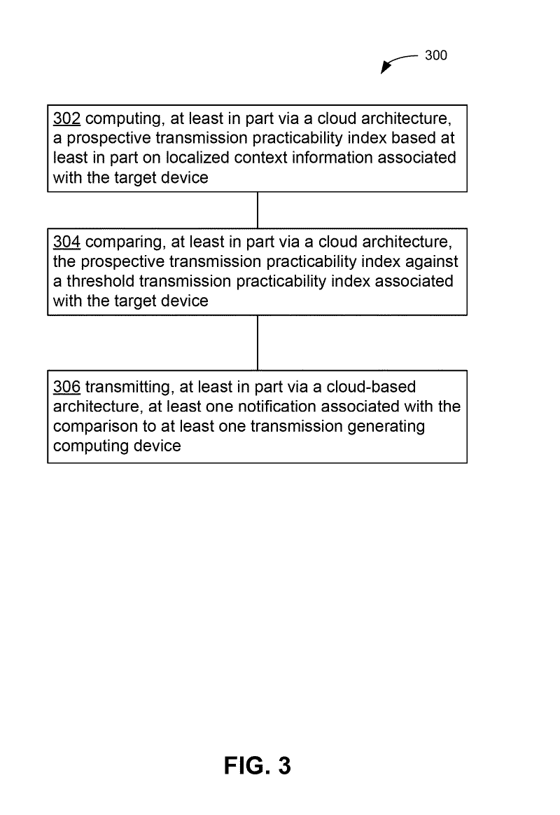

FIG. 3 and the following figures include various examples of operational flows, discussions and explanations may be provided with respect to the above-described exemplary environment of FIGS. 1-2. However, it should be understood that the operational flows may be executed in a number of other environments and contexts, and/or in modified versions of FIGS. 1-2. In addition, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

FIG. 3 illustrates an operational procedure 300 for practicing aspects of the present disclosure including operations 302, 304 and 306.

Operation 302 illustrates computing, at least in part via a cloud architecture, a prospective transmission practicability index based at least in part on localized context information associated with a target device. For example, as shown in FIGS. 1-2, it may be the case that the message transmission server application 105′ may differentiate between varying local environments and/or network connectivity parameters based on context data 108 (e.g. location data, connection data, environmental data) associated with a given target computing device 101′ and only authorize transmission of messages 106 to the target computing device 101′ when threshold contextual data parameters are satisfied for a target computing device 101′. A target computing device 101′ may include one or more context sensors 111. Upon enqueuing a message 106 intended for a given target computing device 101′, the message transmission server application 105′ may query one or more of the context sensors 111 of the target computing device 101′ to obtain context data 108 associated with the target computing device 101′. Alternately, the target computing device 101′ may periodically provide context data 108 to the message transmission server application 105′. The server data store 109 may maintain reference context data 112 corresponding to potential context data 108 which may be received from a target computing device 101′. The reference context data 112 may be mapped to one or more prospective transmission practicability indices 113 associated with practicalities (e.g. likelihood of successful transmission of a message 106 to target computing device 101′ and/or a resultant perception of the message 106 by an end-user) of transmission of a message 106 to the target computing device 101′ under certain conditions defined by context data 108 (e.g. a high probability may exist for a target computing device 101′ having a high power level, a location close to a high-bandwidth wireless network node and an indicated high user device use level; a low probability may exist for a device having a low power level, a location distant from a low-bandwidth wireless network node and an indicated low user device use level). The message transmission server application 105′ may compute a prospective transmission practicability index 113 by comparing the received context data 108 to the reference context data 112 (e.g. determining a range of reference context data 112 into which the context data 108 falls) and assign a prospective transmission practicability index 113 to the target computing device 101′ according to the mapping between the reference context data 112 and the prospective transmission practicability index 113.

Operation 304 illustrates comparing, at least in part via a cloud architecture, the prospective transmission practicability index against a threshold transmission practicability index associated with the target device. For example, as shown in FIGS. 1-2, upon the computation of prospective transmission practicability index 113 value associated with the received context data 108 as described with respect to operation 302, the message transmission server application 105′ may compare that prospective transmission practicability index 113 associated with the received context data 108 to a threshold prospective transmission practicability index 110 (e.g. a threshold quantification indicative of context data 108 having characteristics reflecting a likelihood of success in transmitting a message 106 to the target computing device 101′) associated with (e.g. mapped to in a look-up table having entries for one or more computing devices 101) the target computing device 101′ and maintained by the server data store 109 of the server data store 109.

Operation 306 illustrates transmitting, at least in part via a cloud-based architecture, at least one notification associated with the comparison to at least one transmission generating computing device. For example, it may be the case that a user of a message generating computing device 101 may desire to know the practicality of transmitting a message 106 to a target computing device 101′ resulting from localized context information associated with the target computing device 101′. As such, as shown in FIGS. 1-2, upon a determination that the prospective transmission practicability index 113 associated with the received context data 108 does or does not correspond with the threshold prospective transmission practicability index 110 (e.g. is within a tolerance range, meets or exceeds the threshold, etc.), the message transmission server application 105′ may provide at least one notification 121 to the web browser application 104 of the message generating computing device 101 indicative of the practicality of the transmission of a message 106 to a target computing device 101′. For example, if the context data 108 is of such a nature that a likelihood of success in transmitting a message 106 to the target computing device 101′ is low due to various factors (e.g. the target computing device 101′ being in a remote location, having a low power level, target computing device 101′ device usage and the like), the message transmission server application 105′ may transmit a notification 121 (e.g. an e-mail, text message, and the like) indicating such a likelihood to the message generating computing device 101. For example, the notification 121 may include an estimated delivery time of a message 106 (if any), a summary of the localized context data for the target computing device 101′, and the like. Such a notification may allow a user of the message generating computing device 101 an opportunity to attempt and alternate avenue of communication with a user of the target computing device 101′ or at least be made aware that the user of the target computing device 101′ may not receive the message 106.

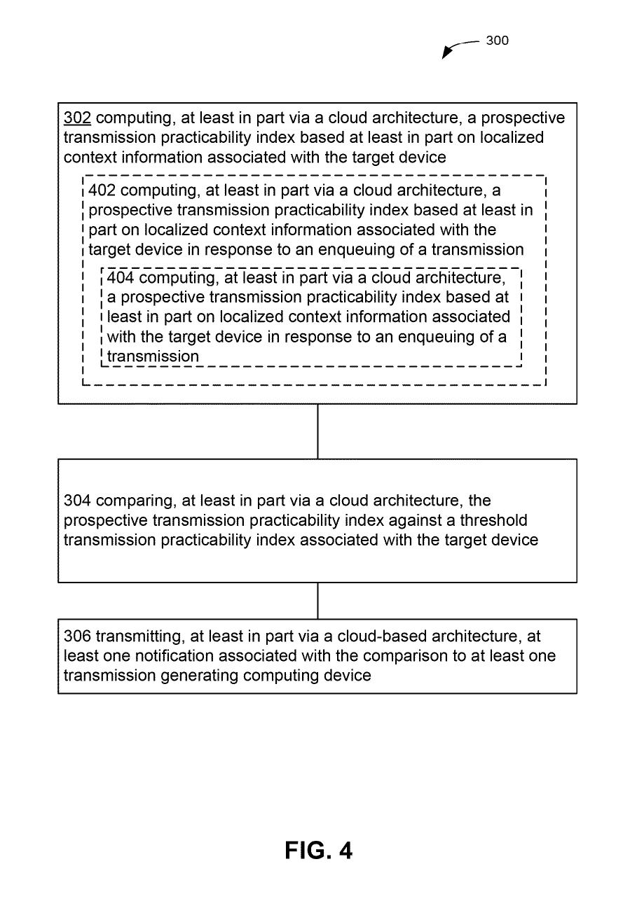

FIG. 4 illustrates an example embodiment where operation 302 of example operational flow 300 of FIG. 3 may include at least one additional operation. Additional operations may include an operation 402 and/or 404.

Operation 402 illustrates computing, at least in part via a cloud architecture, a prospective transmission practicability index based at least in part on localized context information associated with a target device in response to an enqueuing of a transmission. For example, as shown in FIGS. 1-2, a user of the computing device 101 may employ the message creation server application 105 to create a message 106 for transmission to the target computing device 101′. When the message 106 is ready for transmission, the message 106 may be enqueued in the message storage queue 107. In response to the enqueuing of the message 106 for transmission to the target computing device 101′, the message transmission server application 105′ running on the cloud-based server 103 may determine a prospective transmission practicability index value for a transmission of a message 106 (e.g. as described with respect to operation 302).

Operation 404 illustrates computing, at least in part via a cloud architecture, a prospective transmission practicability index based at least in part on localized context information associated with a target device in response to an enqueuing of a transmission. For example, as shown in FIGS. 1-2, a user of the computing device 101 may employ the message creation server application 105 to create a number of messages 106 for transmission to the target computing device 101′. When a message 106 is ready for transmission, the message 106 may be enqueued in the message storage queue 107. Over time, the message storage queue 107 may accumulate a number of messages 106 for transmission to the target computing device 101′. In response to the enqueuing of a threshold number of messages 106 for transmission to the target computing device 101′ (e.g. a threshold number stored in server data store 109, a threshold number set according to a user setting, etc.), the message transmission server application 105′ running on the cloud-based server 103 may determine a prospective transmission practicability index value for transmission of one or more messages 106 (e.g. as described with respect to operation 302).

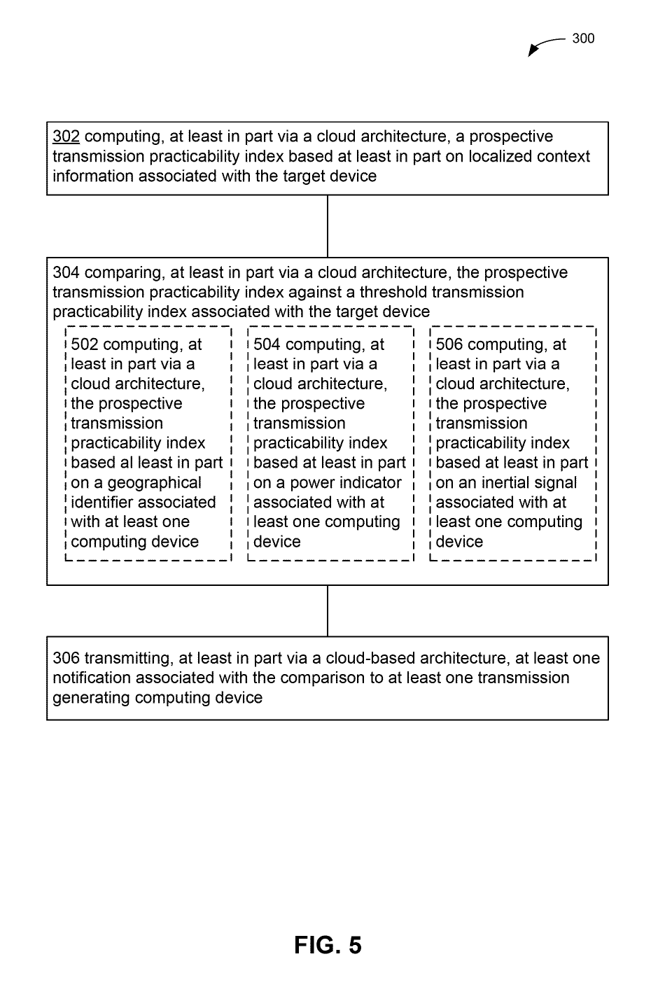

FIG. 5 further illustrates an example embodiment where operation 302 of example operational flow 300 of FIG. 3 may include at least one additional operation. Additional operations may include an operation 502, 504 and/or 506.

Operation 502 illustrates computing, at least in part via a cloud architecture, the prospective transmission practicability index based al least in part on a geographical identifier associated with at least one computing device. For example, it may be the case that the message transmission server application 105′ may differentiate may differentiate the practicality of transmission of messages 106 to target computing devices 101′ based on the respective geographic locations of the target computing devices 101′ (e.g. transmissions of messages 106 to target computing devices 101′ in a first geographic location (e.g. a remote wilderness area) may be less practical than transmission of messages 106 to target computing devices 101′ in a second geographic location (e.g. within a city) due to signal transmission difficulties inherent with the location). The reference context data 112 associated with various geographic locations may be mapped to a prospective transmission practicability index 113. A target computing device 101′ may include a global positioning system sensor 114. Upon enqueuing a message 106 intended for a given target computing device 101′, the message transmission server application 105′ may query the global positioning system sensor 114 of the target computing device 101′ for geographic location context data 108 for the target computing device 101′ and compare that geographic location context data 108 to the reference context data 112 in order to compute a prospective transmission practicability index 113 for that target computing device 101′ according to the mapping between the reference context data 112 and the prospective transmission practicability index 113.

Operation 504 illustrates computing, at least in part via a cloud architecture, the prospective transmission practicability index based at least in part on a power indicator associated with at least one computing device. For example, it may be the case that the message transmission server application 105′ may differentiate the practicality of transmission of messages 106 to target computing devices 101′ based on the performance characteristics, system status, remaining battery life etc. (e.g. transmissions of messages 106 to target computing devices 101′ having a high level of remaining battery life may be more practical than transmission of messages 106 to target computing devices 101′ having a low level of remaining battery life). The reference context data 112 associated with a device power level context data 108 may be mapped to a prospective transmission practicability index 113. A target computing device 101′ may include a power level sensor 115 (e.g. a battery level sensor). Upon enqueuing a message 106 intended for a given target computing device 101′, the message transmission server application 105′ may query the power level sensor 115 of the target computing device 101′ for its current power level context data 108 for the target computing device 101′ and compare that power level context data 108 to the reference context data 112 in order to compute a prospective transmission practicability index 113 for that target computing device 101′ according to the mapping between the reference context data 112 and the prospective transmission practicability index 113.

Operation 506 illustrates computing, at least in part via a cloud architecture, the prospective transmission practicability index based at least in part on an inertial signal associated with at least one computing device. For example, it may be the case that the message transmission server application 105′ may differentiate the practicality of transmission of messages 106 to target computing devices 101′ based on a usage profile of the target computing devices 101′ (e.g. transmissions of messages 106 to target computing devices 101′ having a high level of device usage may occur on a time scale shorter than transmission of messages 106 to target computing devices 101′ having a low level of usage). The reference context data 112 associated with a device power level context data 108 may be mapped to a prospective transmission practicability index 113. A target computing device 101′ may include an inertial sensor 116 (e.g. an accelerometer) configured to detect motion of the target computing device 101′ indicative of use of the target computing device 101′. Upon enqueuing a message 106 intended for a given target computing device 101′, the message transmission server application 105′ may query the inertial sensor 116 of the target computing device 101′ for an indication of usage of the target computing device 101′ and compare that usage level context data 108 to the reference context data 112 in order to compute a prospective transmission practicability index 113 for that target computing device 101′ according to the mapping between the reference context data 112 and the prospective transmission practicability index 113.

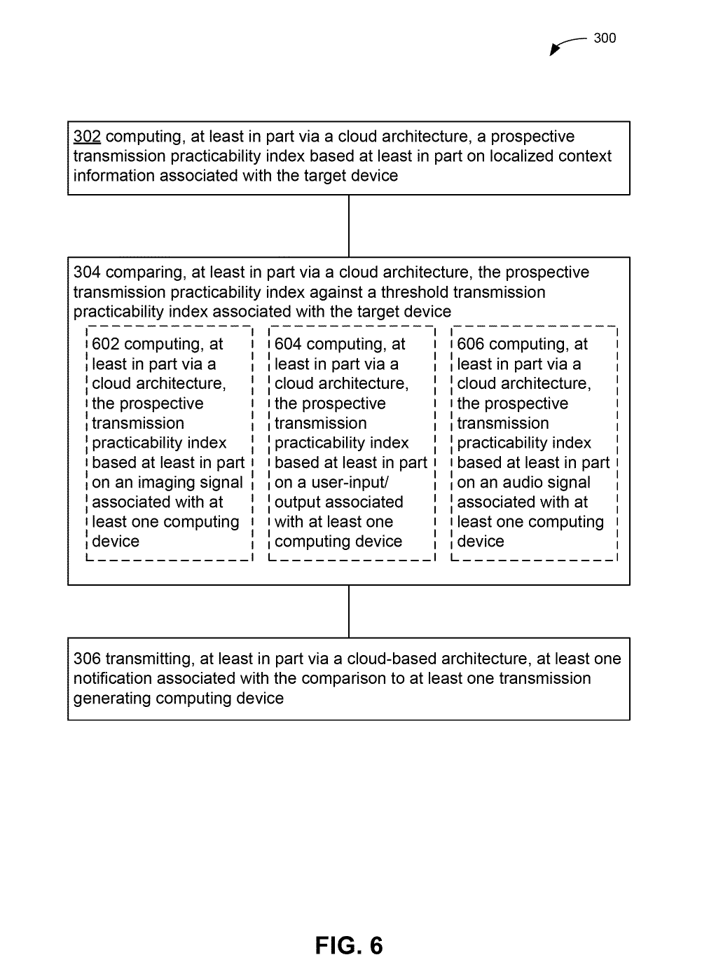

FIG. 6 illustrates an example embodiment where operation 302 of example operational flow 300 of FIG. 3 may include at least one additional operation. Additional operations may include an operation 602 and/or 604.

Operation 602 illustrates computing, at least in part via a cloud architecture, the prospective transmission practicability index based at least in part on an imaging signal associated with at least one computing device. For example, it may be the case that the message transmission server application 105′ may differentiate the practicality of transmission of messages 106 to target computing devices 101′ based on the respective environment or geographic locations of the target computing devices 101′ (e.g. transmissions of messages 106 to target computing devices 101′ in a first environment or location (e.g. an office during the daytime) may be more practical than transmission of messages 106 to target computing devices 101′ in a second environment or location (e.g. at a home during the night)). The reference context data 112 associated with various geographic locations may be mapped to a prospective transmission practicability index 113. A target computing device 101′ may include an image capture sensor 117 (e.g. a camera configured for still image or video capture). Upon enqueuing a message 106 intended for a given target computing device 101′, the message transmission server application 105′ may query the image capture sensor 117 of the target computing device 101′ to obtain one or more images of the current environment of the target computing device 101′. The image of the environment may be analyzed (e.g. by image recognition software running on the cloud-based server 103) to determine the current environment of the target computing device 101′ and compared to image reference context data 112 in order to compute a prospective transmission practicability index 113 for that target computing device 101′ according to the mapping between the image reference context data 112 and the prospective transmission practicability index 113.

Operation 604 illustrates computing, at least in part via a cloud architecture, the prospective transmission practicability index based at least in part on a user-input/output associated with at least one computing device. For example, it may be the case that the message transmission server application 105′ may differentiate the practicality of transmission of messages 106 to target computing devices 101′ based on a usage profile of the target computing devices 101′ (e.g. transmissions of messages 106 to target computing devices 101′ having a high level of device usage may be more likely to be perceived by an end-user than messages 106 to target computing devices 101′ having a low level of usage). A target computing device 101′ may include a user input/output device 118 (e.g. a touchscreen, a keypad, a display, a microphone, a speaker, etc.) configured to receive/provide user input/output of the target computing device 101′ (e.g. for control of one or more functions of the target computing device 101′). Upon enqueuing a message 106 intended for a given target computing device 101′, the message transmission server application 105′ may query the user input/output device 118 of the target computing device 101′ for device usage context data 108 for the target computing device 101′ and compare that device usage context data 108 to the reference context data 112 in order to compute a prospective transmission practicability index 113 for that target computing device 101′ according to the mapping between the reference context data 112 and the prospective transmission practicability index 113.

Operation 606 illustrates computing, at least in part via a cloud architecture, the prospective transmission practicability index based at least in part on an audio signal associated with at least one computing device. For example, it may be the case that the message transmission server application 105′ may differentiate the practicality of transmission of messages 106 to target computing devices 101′ based on the respective environment or geographic locations of the target computing devices 101′ (e.g. transmissions of messages 106 to target computing devices 101′ in a first environment or location (e.g. an office during the daytime) may be more practical than transmission of messages 106 to target computing devices 101′ in a second environment or location (e.g. at a home during the night)). The reference context data 112 associated with various geographic locations may be mapped to a prospective transmission practicability index 113. A target computing device 101′ may include an audio capture sensor 119 (e.g. a microphone configured for recording environmental sounds). Upon enqueuing a message 106 intended for a given target computing device 101′, the message transmission server application 105′ may query the audio capture sensor 119 of the target computing device 101′ to obtain one or more sound recordings of the current environment of the target computing device 101′. The sound recordings of the environment may be analyzed (e.g. by sound recognition software running on the cloud-based server 103) to determine the current environment of the target computing device 101′ and compared to sound reference context data 112 in order to compute a prospective transmission practicability index 113 for that target computing device 101′ according to the mapping between the image reference context data 112 and the prospective transmission practicability index 113.

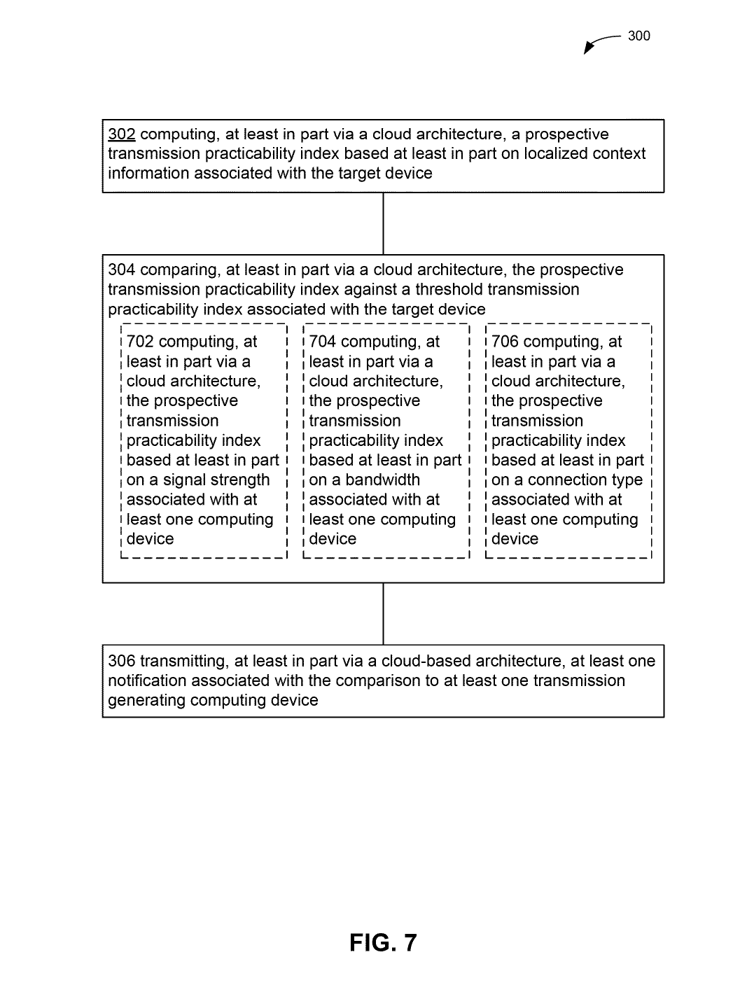

FIG. 7 illustrates an example embodiment where operation 302 of example operational flow 300 of FIG. 3 may include at least one additional operation. Additional operations may include an operation 702, 704 and/or 708.

Operation 702 illustrates computing, at least in part via a cloud architecture, the prospective transmission practicability index based at least in part on a signal strength associated with at least one computing device. For example, it may be the case that the message transmission server application 105′ may differentiate the practicality of transmission of messages 106 to target computing devices 101′ based on differing network connectivity (e.g. transmissions of messages 106 to target computing devices 101′ via a network 102 connection having a first signal strength may be more or less practical than transmission of messages 106 to target computing devices 101′ via a network 102 connection having a second signal strength). The reference context data 112 may include one or more signal strength ranges associated with communications signal strengths for target computing devices 101′ connected to network 102. One or more signal strength ranges may be mapped to at least one threshold prospective transmission practicability index 110 in the server data store 109. Upon enqueuing a message 106 intended for a given target computing device 101′, the message transmission server application 105′ may query the network 102 and/or the target computing device 101′ for the signal strength context data 108 indicative of a signal strength between the target computing device 101′ and the network 102 and compare that signal strength context data 108 to the reference context data 112 in order to compute a prospective transmission practicability index 113 for that target computing device 101′ according to the mapping between the reference context data 112 and the prospective transmission practicability index 113.

Operation 704 illustrates computing, at least in part via a cloud architecture, the prospective transmission practicability index based at least in part on a bandwidth associated with at least one computing device. For example, it may be the case that the message transmission server application 105′ may differentiate the practicality of transmission of messages 106 to target computing devices 101′ based on differing network connectivity (e.g. transmissions of messages 106 to target computing devices 101′ via a network 102 connection having a first bandwidth may be more or less practical than transmission of messages 106 to target computing devices 101′ via a network 102 connection having a second bandwidth). The reference context data 112 associated with various bandwidth (e.g. data throughput metrics) ranges may be mapped to a prospective transmission practicability index 113. Upon enqueuing a message 106 intended for a given target computing device 101′, the message transmission server application 105′ may query the network 102 and/or the target computing device 101′ for the bandwidth between the target computing device 101′ and the network 102 and compare that bandwidth to the reference context data 112 in order to compute a prospective transmission practicability index 113 for that target computing device 101′ according to the mapping between the reference context data 112 and the prospective transmission practicability index 113.

Operation 706 illustrates computing, at least in part via a cloud architecture, the prospective transmission practicability index based at least in part on a connection type associated with at least one computing device. For example, it may be the case that the message transmission server application 105′ may differentiate the practicality of transmission of messages 106 to target computing devices 101′ based differing network connectivity (e.g. transmissions of messages 106 to target computing devices 101′ via a wired network 102 connection type may be more or less practical than transmission of messages 106 to target computing devices 101′ having a wireless network 102 connection type). The reference context data 112 associated with various network connection types may be mapped to a prospective transmission practicability index 113. Upon enqueuing a message 106 intended for a given target computing device 101′, the message transmission server application 105′ may query the network 102 and/or the target computing device 101′ for the network connection type between the target computing device 101′ and the network 102 and compare that network connection type to the reference context data 112 in order to compute a prospective transmission practicability index 113 for that target computing device 101′ according to the mapping between the network connection type reference context data 112 and the prospective transmission practicability index 113

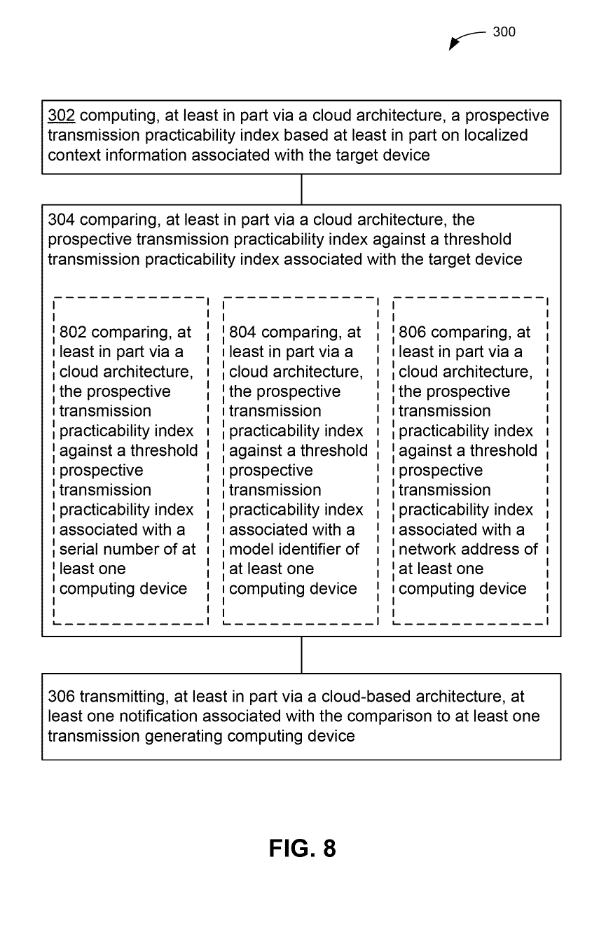

FIG. 8 illustrates an example embodiment where operation 304 of example operational flow 300 of FIG. 3 may include at least one additional operation. Additional operations may include an operation 802, 804 and/or 806.

Operation 802 illustrates comparing, at least in part via a cloud architecture, the prospective transmission practicability index against a threshold prospective transmission practicability index associated with a serial number of at least one computing device. For example, as shown in FIGS. 1-2, upon the computation of a prospective transmission practicability index 113 for a transmission to a target computing device 101′ as described with respect to operation 302, the message transmission server application 105′ may compare that prospective transmission practicability index 113 to a threshold prospective transmission practicability index 110 associated with the target computing device 101′ and maintained by the server data store 109 of the server data store 109. It may be the case that the message transmission server application 105′ may differentiate between multiple target computing devices 101′ and maintain distinct threshold prospective transmission practicability indices 110 for each target computing device 101′ or groups of target computing devices 101′ based on their respective device performance characteristics, bandwidth usage, usage histories, etc. (e.g. transmissions of messages 106 to a target computing device 101′ having a first serial number may be more or less practical than transmission of messages 106 to a target computing device 101′ having a second serial number). In one embodiment, the server data store 109 may maintain a device ID database 120. The device ID database 120 may include one or more serial numbers assigned to target computing devices 101′. One or more serial numbers assigned to respective target computing devices 101′ may be mapped to at least one threshold prospective transmission practicability index 110 in the server data store 109. Upon enqueuing a message 106 intended for a given target computing device 101′, the message transmission server application 105′ may query the target computing device 101′ for its serial number, and obtain the appropriate threshold prospective transmission practicability index 110 for that target computing device 101′ according to the mapping between the serial number for that target computing device 101′ in the device ID database 120 and the threshold prospective transmission practicability index 110.

Operation 804 illustrates comparing, at least in part via a cloud architecture, the prospective transmission practicability index against a threshold prospective transmission practicability index associated with a model identifier of at least one computing device. For example, as shown in FIGS. 1-2, upon the computation of a prospective transmission practicability index 113 for a transmission to a target computing device 101′ as described with respect to operation 302, the message transmission server application 105′ may compare that prospective transmission practicability index 113 to a threshold prospective transmission practicability index 110 associated with the target computing device 101′ and maintained by the server data store 109 of the server data store 109. It may be the case that the message transmission server application 105′ may differentiate between multiple target computing devices 101′ and maintain distinct threshold prospective transmission practicability indices 110 for groups of target computing devices 101′ based on their respective device performance characteristics, bandwidth usage (e.g. transmissions of messages 106 to target computing device 101′ models having a multi-core processor may be more or less practical than transmission of messages 106 to target computing device 101′ models having a single-core processor). For example, the device ID database 120 may include one or more model identifiers (e.g. a model identifier associate with a vendor of target computing devices 101′ such as Apple®, Sony®, Samsung®, Google®, HTC® and/or device-specific model identifiers) associated with the target computing devices 101′. One or more model identifiers assigned to respective target computing devices 101′ may be mapped to at least one threshold prospective transmission practicability index 110 in the server data store 109. Upon enqueuing a message 106 intended for a given target computing device 101′, the message transmission server application 105′ may query the target computing device 101′ for its model identifier, and obtain the appropriate threshold prospective transmission practicability index 110 for that target computing device 101′ according to the mapping between the model identifier for that target computing device 101′ in the device ID database 120 and the threshold prospective transmission practicability index 110.

Operation 806 illustrates comparing, at least in part via a cloud architecture, the prospective transmission practicability index against a threshold prospective transmission practicability index associated with a network address of at least one computing device. For example, as shown in FIGS. 1-2, upon the computation of a prospective transmission practicability index 113 for a transmission to a target computing device 101′ as described with respect to operation 302, the message transmission server application 105′ may compare that prospective transmission practicability index 113 to a threshold prospective transmission practicability index 110 associated with the target computing device 101′ and maintained by the server data store 109 of the server data store 109. It may be the case that the message transmission server application 105′ may differentiate between multiple target computing devices 101′ and maintain distinct threshold prospective transmission practicability indices for each target computing device 101′ or groups of target computing devices 101′ based on the network connectivity for various branches of network 102 (e.g. transmissions of messages 106 to target computing devices 101′ in connected to a portion of the network 102 may be more or less practical than transmission of messages 106 to target computing devices 101′ on a wired portion of the network 102). For example, the device ID database 120 may include one or more network addresses (e.g. IP addresses for a LAN, WAN, the Internet, etc.) associated with the target computing devices 101′ connected to network 102. One or more network addresses assigned to respective target computing devices 101′ may be mapped to at least one threshold prospective transmission practicability index 110 in the server data store 109. Upon enqueuing a message 106 intended for a given target computing device 101′, the message transmission server application 105′ may query the target computing device 101′ for its network address or extract the destination network address from the message 106 itself, and obtain the appropriate threshold prospective transmission practicability index 110 for that target computing device 101′ according to the mapping between the network address for that target computing device 101′ in the device ID database 120 and the threshold prospective transmission practicability index 110.

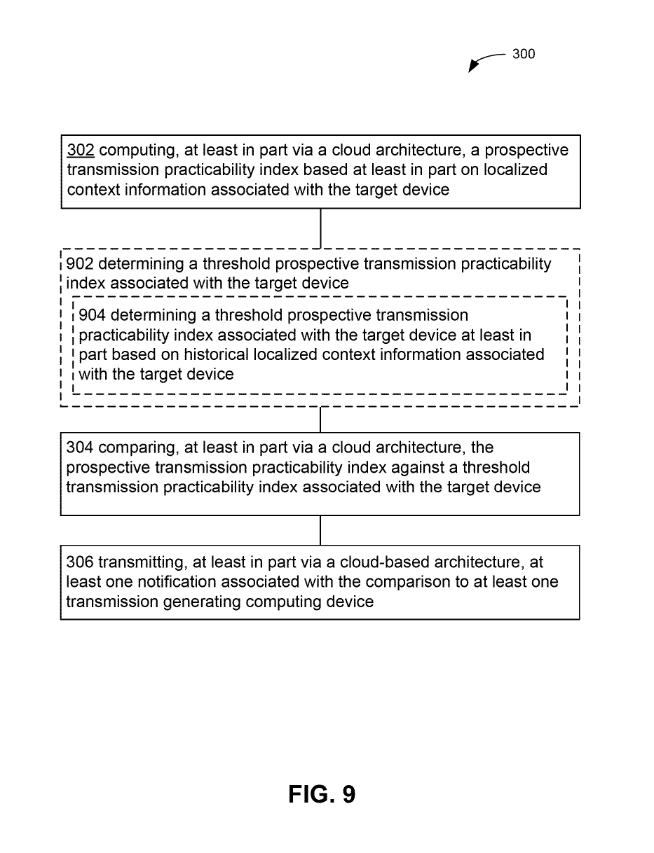

FIG. 9 illustrates an example embodiment where example operational flow 300 of FIG. 3 may include at least one additional operation. Additional operations may include an operation 902.

Operation 902 illustrates determining a threshold prospective transmission practicability index associated with the target device. For example, as shown in FIGS. 1-2, the message transmission server application 105′ may be configured to compute and store a threshold prospective transmission practicability index 110 based on multiple parameters. For example, the threshold prospective transmission practicability index 110 may be a combination of several threshold prospective transmission practicability indices 110 associated with location, power level, usage, and/or environmental factors associated with context data 108 of a target computing device 101′. The message transmission server application 105′ aggregate two or more of these factors to compute a combined (e.g. averaged, weighted average, etc.) threshold prospective transmission practicability index 110. Such computed threshold prospective transmission practicability indices 110 may vary according to one or more inputs (e.g. one or more user inputs) which control the relative weighting of the threshold prospective transmission practicability indices 110.

Operation 904 illustrates determining a threshold prospective transmission practicability index associated with the target device at least in part based on historical localized context information associated with the target device. For example, as shown in FIGS. 1-2, over time the message transmission server application 105′ may transmit messages 106 to target computing devices 101′ and receive context data 108 feedback from target computing devices 101′. Historical data regarding the transmission of messages 106 in varying contextual circumstances of the target computing devices 101′ (e.g. success/failure data, transmission time data, retry data, message volume data) may be used by the message transmission server application 105′ to refine the threshold prospective transmission practicability indices 110 to accurately reflect operations of the cloud-based computing system 100. For example, when transmission of messages 106 sent to target computing devices 101′ over a connection with a given bandwidth historically fail due to bandwidth limitations, it may be the case that the threshold prospective transmission practicability index 110 associated with bandwidth for those target computing devices 101′ should be increased such that higher bandwidth context data 108 is required to satisfy the threshold prospective transmission practicability index 110 (e.g. a higher bandwidth connection) thereby resulting in more timely delivery. In another example, it may be the case that transmission of messages 106 sent to target computing devices 101′ in a given geographic location historically occur in an untimely manner. However, detection of context data 108 indicating a stronger communications signal strength may indicate the recent construction of network access point proximate to the geographic location and that the threshold prospective transmission practicability index 110 with respect to that geographic location may be lowered.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

1. A method comprising:
computing, at least in part via a cloud architecture, a prospective transmission practicability index based at least in part on localized context information associated with a target device;
comparing, at least in part via a cloud architecture, the prospective transmission practicability index against a threshold transmission practicability index associated with the target device; and
transmitting, at least in part via a cloud-based architecture, at least one notification associated with the comparison to at least one transmission generating computing device.

2. The method of claim 1, wherein the cloud-based architecture comprises:
a cloud-based server in communication with the least one message generating computing device and at least one target device via a communications network.

3. The method of claim 1, wherein the computing, at least in part via a cloud architecture, a prospective transmission practicability index based at least in part on localized context information associated with a target device includes:
computing, at least in part via a cloud architecture, a prospective transmission practicability index based at least in part on localized context information associated with a target device in response to an enqueuing of a transmission.

4. The method of claim 3, wherein the computing, at least in part via a cloud architecture, a prospective transmission practicability index based at least in part on localized context information associated with a target device in response to an enqueuing of a transmission includes:
computing, at least in part via a cloud architecture, a prospective transmission practicability index based at least in part on localized context information associated with a target device in response to an enqueuing of a transmission in response to an enqueuing of a threshold number of transmissions.

5. The method of claim 1, wherein the computing, at least in part via a cloud architecture, a prospective transmission practicability index based at least in part on localized context information associated with a target device includes:
computing, at least in part via a cloud architecture, the prospective transmission practicability index based al least in part on a geographical identifier associated with at least one computing device.

6. The method of claim 1, wherein the computing, at least in part via a cloud architecture, a prospective transmission practicability index based at least in part on localized context information associated with a target device includes:
computing, at least in part via a cloud architecture, the prospective transmission practicability index based at least in part on a power indicator associated with at least one computing device.

7. The method of claim 1, wherein the computing, at least in part via a cloud architecture, a prospective transmission practicability index based at least in part on localized context information associated with a target device includes:
computing, at least in part via a cloud architecture, the prospective transmission practicability index based at least in part on an inertial signal associated with at least one computing device.

8. The method of claim 1, wherein the computing, at least in part via a cloud architecture, a prospective transmission practicability index based at least in part on localized context information associated with a target device includes:
computing, at least in part via a cloud architecture, the prospective transmission practicability index based at least in part on an imaging signal associated with at least one computing device.

9. The method of claim 1, wherein the computing, at least in part via a cloud architecture, a prospective transmission practicability index based at least in part on localized context information associated with a target device includes:
computing, at least in part via a cloud architecture, the prospective transmission practicability index based at least in part on a user-input/output associated with at least one computing device.

10. The method of claim 1, wherein the computing, at least in part via a cloud architecture, a prospective transmission practicability index based at least in part on localized context information associated with a target device includes:
computing, at least in part via a cloud architecture, the prospective transmission practicability index based at least in part on an audio signal associated with at least one computing device.

11. The method of claim 1, wherein the computing, at least in part via a cloud architecture, a prospective transmission practicability index based at least in part on localized context information associated with a target device includes:
computing, at least in part via a cloud architecture, the prospective transmission practicability index based at least in part on a signal strength associated with at least one computing device.

12. The method of claim 1, wherein the computing, at least in part via a cloud architecture, a prospective transmission practicability index based at least in part on localized context information associated with a target device includes:
computing, at least in part via a cloud architecture, the prospective transmission practicability index based at least in part on a bandwidth associated with at least one computing device.

13. The method of claim 1, wherein the computing, at least in part via a cloud architecture, a prospective transmission practicability index based at least in part on localized context information associated with a target device includes:
computing, at least in part via a cloud architecture, the prospective transmission practicability index based at least in part on a connection type associated with at least one computing device.

14. The method of claim 1, wherein the comparing, at least in part via a cloud architecture, the prospective transmission practicability index against a threshold transmission practicability index associated with the target device includes:
comparing, at least in part via a cloud architecture, the prospective transmission practicability index against a threshold prospective transmission practicability index associated with a serial number of at least one computing device.

15. The method of claim 1, wherein the comparing, at least in part via a cloud architecture, the prospective transmission practicability index against a threshold transmission practicability index associated with the target device includes:
comparing, at least in part via a cloud architecture, the prospective transmission practicability index against a threshold prospective transmission practicability index associated with a model identifier of at least one computing device.

16. The method of claim 1, wherein the comparing, at least in part via a cloud architecture, the prospective transmission practicability index against a threshold transmission practicability index associated with the target device includes:
comparing, at least in part via a cloud architecture, the prospective transmission practicability index against a threshold prospective transmission practicability index associated with a network address of at least one computing device.

17. The method of claim 1, further comprising:
determining a threshold prospective transmission practicability index associated with the target device.

18. The method of claim 17, further comprising:
determining a threshold prospective transmission practicability index associated with the target device at least in part based on historical localized context information associated with the target device.

19. A system comprising:
at least one target device configured for receiving data transmitted from a cloud-based server device; and
a cloud-based server device configured for:
computing, at least in part via a cloud architecture, a prospective transmission practicability index based at least in part on localized context information associated with a target device;
comparing, at least in part via a cloud architecture, the prospective transmission practicability index against a threshold transmission practicability index associated with the target device; and
transmitting, at least in part via a cloud-based architecture, at least one notification associated with the comparison to at least one transmission generating computing device.

20. The system of claim 19, wherein the computing, at least in part via a cloud architecture, a prospective transmission practicability index based at least in part on localized context information associated with a target device includes:
computing, at least in part via a cloud architecture, a prospective transmission practicability index based at least in part on localized context information associated with a target device in response to an enqueuing of a transmission.

21. The system of claim 19, wherein the computing, at least in part via a cloud architecture, a prospective transmission practicability index based at least in part on localized context information associated with a target device includes:
computing, at least in part via a cloud architecture, a prospective transmission practicability index based at least in part on localized context information associated with a target device in response to an enqueuing of a threshold number of transmissions.

22. The system of claim 19, wherein the comparing, at least in part via a cloud architecture, the prospective transmission practicability index against a threshold transmission practicability index associated with the target device includes:
comparing, at least in part via a cloud architecture, the prospective transmission practicability index against a threshold prospective transmission practicability index associated with a serial number of at least one computing device.

23. The system of claim 19, wherein the comparing, at least in part via a cloud architecture, the prospective transmission practicability index against a threshold transmission practicability index associated with the target device includes:
comparing, at least in part via a cloud architecture, the prospective transmission practicability index against a threshold prospective transmission practicability index associated with a model identifier of at least one computing device.

24. The system of claim 19, wherein the comparing, at least in part via a cloud architecture, the prospective transmission practicability index against a threshold transmission practicability index associated with the target device includes:
comparing, at least in part via a cloud architecture, the prospective transmission practicability index against a threshold prospective transmission practicability index associated with a network address of at least one computing device.

25. The system of claim 19, wherein the comparing, at least in part via a cloud architecture, the prospective transmission practicability index against a threshold transmission practicability index associated with the target device includes:
computing, at least in part via a cloud architecture, a prospective transmission practicability index based at least in part on localized context information associated with a target device.

26. The system of claim 25, wherein the comparing, at least in part via a cloud architecture, the prospective transmission practicability index against a threshold transmission practicability index associated with the target device includes:
computing, at least in part via a cloud architecture, the prospective transmission practicability index based al least in part on a geographical identifier associated with at least one computing device.

27. The system of claim 25, wherein the comparing, at least in part via a cloud architecture, the prospective transmission practicability index against a threshold transmission practicability index associated with the target device includes:
computing, at least in part via a cloud architecture, the prospective transmission practicability index based at least in part on a power indicator associated with at least one computing device.

28. The system of claim 25, wherein the comparing, at least in part via a cloud architecture, the prospective transmission practicability index against a threshold transmission practicability index associated with the target device includes:
computing, at least in part via a cloud architecture, the prospective transmission practicability index based at least in part on an inertial signal associated with at least one computing device.

29. The system of claim 25, wherein the comparing, at least in part via a cloud architecture, the prospective transmission practicability index against a threshold transmission practicability index associated with the target device includes:
computing, at least in part via a cloud architecture, the prospective transmission practicability index based at least in part on an imaging signal associated with at least one computing device.

30. The system of claim 25, wherein the comparing, at least in part via a cloud architecture, the prospective transmission practicability index against a threshold transmission practicability index associated with the target device includes:
computing, at least in part via a cloud architecture, the prospective transmission practicability index based at least in part on a user-input/output associated with at least one computing device.

31. The system of claim 25, wherein the comparing, at least in part via a cloud architecture, the prospective transmission practicability index against a threshold transmission practicability index associated with the target device includes:
computing, at least in part via a cloud architecture, the prospective transmission practicability index based at least in part on an audio signal associated with at least one computing device.

32. The system of claim 25, wherein the computing, at least in part via a cloud architecture, a prospective transmission practicability index based at least in part on localized context information associated with a target device includes:
computing, at least in part via a cloud architecture, the prospective transmission practicability index based at least in part on a signal strength associated with at least one computing device.

33. The system of claim 25, wherein the computing, at least in part via a cloud architecture, a prospective transmission practicability index based at least in part on localized context information associated with a target device includes:
computing, at least in part via a cloud architecture, the prospective transmission practicability index based at least in part on a bandwidth associated with at least one computing device.

34. The system of claim 25, wherein the computing, at least in part via a cloud architecture, a prospective transmission practicability index based at least in part on localized context information associated with a target device includes:
computing, at least in part via a cloud architecture, the prospective transmission practicability index based at least in part on a connection type associated with at least one computing device.

35. The system of claim 25, wherein the cloud-based server device is further configured for:
determining a threshold prospective transmission practicability index associated with the target device.

36. The system of claim 35, wherein the cloud-based server device is further configured for:
determining a threshold prospective transmission practicability index associated with the target device at least in part based on historical localized context information associated with the target device.

37. A system comprising:
means for computing, at least in part via a cloud architecture, a prospective transmission practicability index based at least in part on localized context information associated with a target device;
means for comparing, at least in part via a cloud architecture, the prospective transmission practicability index against a threshold transmission practicability index associated with the target device; and
means for transmitting, at least in part via a cloud-based architecture, at least one notification associated with the comparison to at least one transmission generating computing device.

38-39. (canceled)

40. The system of claim 37, wherein the means for comparing, at least in part via a cloud architecture, the prospective transmission practicability index against a threshold transmission practicability index associated with the target device includes:
means for comparing, at least in part via a cloud architecture, the prospective transmission practicability index against a threshold prospective transmission practicability index associated with a serial number of at least one computing device.

41. The system of claim 37, wherein the means for comparing, at least in part via a cloud architecture, the prospective transmission practicability index against a threshold transmission practicability index associated with the target device includes:
means for comparing, at least in part via a cloud architecture, the prospective transmission practicability index against a threshold prospective transmission practicability index associated with a model identifier of at least one computing device.

42. The system of claim 37, wherein the means for comparing, at least in part via a cloud architecture, the prospective transmission practicability index against a threshold transmission practicability index associated with the target device includes:
means for comparing, at least in part via a cloud architecture, the prospective transmission practicability index against a threshold prospective transmission practicability index associated with a network address of at least one computing device.

43. The system of claim 37, wherein the means for comparing, at least in part via a cloud architecture, the prospective transmission practicability index against a threshold transmission practicability index associated with the target device includes:
means for computing, at least in part via a cloud architecture, a prospective transmission practicability index based at least in part on localized context information associated with a target device.

44. The system of claim 43, wherein the means for comparing, at least in part via a cloud architecture, the prospective transmission practicability index against a threshold transmission practicability index associated with the target device includes:
means for computing, at least in part via a cloud architecture, the prospective transmission practicability index based al least in part on a geographical identifier associated with at least one computing device.

45. The system of claim 43, wherein the means for comparing, at least in part via a cloud architecture, the prospective transmission practicability index against a threshold transmission practicability index associated with the target device includes:
means for computing, at least in part via a cloud architecture, the prospective transmission practicability index based at least in part on a power indicator associated with at least one computing device.

46. The system of claim 43, wherein the means for comparing, at least in part via a cloud architecture, the prospective transmission practicability index against a threshold transmission practicability index associated with the target device includes:
means for computing, at least in part via a cloud architecture, the prospective transmission practicability index based at least in part on an inertial signal associated with at least one computing device.

47. The system of claim 43, wherein the means for comparing, at least in part via a cloud architecture, the prospective transmission practicability index against a threshold transmission practicability index associated with the target device includes:
means for computing, at least in part via a cloud architecture, the prospective transmission practicability index based at least in part on an imaging signal associated with at least one computing device.

48. The system of claim 43, wherein the means for comparing, at least in part via a cloud architecture, the prospective transmission practicability index against a threshold transmission practicability index associated with the target device includes:
means for computing, at least in part via a cloud architecture, the prospective transmission practicability index based at least in part on a user-input/output associated with at least one computing device.

49. The system of claim 43, wherein the means for comparing, at least in part via a cloud architecture, the prospective transmission practicability index against a threshold transmission practicability index associated with the target device includes:
means for computing, at least in part via a cloud architecture, the prospective transmission practicability index based at least in part on an audio signal associated with at least one computing device.

50-54. (canceled)

55. A system comprising:
circuitry for computing, at least in part via a cloud architecture, a prospective transmission practicability index based at least in part on localized context information associated with a target device;
circuitry for comparing, at least in part via a cloud architecture, the prospective transmission practicability index against a threshold transmission practicability index associated with the target device; and
circuitry for transmitting, at least in part via a cloud-based architecture, at least one notification associated with the comparison to at least one transmission generating computing device.

56. A computer-readable medium including computer-readable instructions for execution of a method on a computing device, the method comprising:
computing, at least in part via a cloud architecture, a prospective transmission practicability index based at least in part on localized context information associated with a target device;
comparing, at least in part via a cloud architecture, the prospective transmission practicability index against a threshold transmission practicability index associated with the target device; and
transmitting, at least in part via a cloud-based architecture, at least one notification associated with the comparison to at least one transmission generating computing device.
